(19) United States
(12) Patent Application Publication
(10) Pub. No.: US 2026/0205975 A1
(43) Pub. Date: Jul. 16, 2026

(54) TIMING ERROR GROUP (TEG) REPORTING IN O-RAN DEPLOYMENT

(71) Applicant: QUALCOMM Incorporated, San Diego, CA (US)

(72) Inventors: Mohamad SAYED HASSAN, Paris (FR); Sony AKKARAKARAN, Poway, CA (US); Alexandros MANOLAKOS, Athens, Attikí (GR); Srinivas YERRAMALLI, San Diego, CA (US); Rajat PRAKASH, San Diego, CA (US); Andrei Dragos RADULESCU, La Jolla, CA (US)

(21) Appl. No.: 19/135,779

(22) PCT Filed: Nov. 22, 2023
(86) PCT No.: PCT/US2023/080854

§ 371 Date: Jun. 4, 2025

(30) Foreign Application Priority Data
Jan. 23, 2023 (GR) 20230100049

(51) Int. Cl. H04W 56/00; H04W 48/08

(52) U.S. Cl. CPC H04W 56/0035; H04W 48/08

(57) ABSTRACT

In some implementations, an open radio access network (O-RAN) radio unit (O-RU) may send capability information to an O-RAN distributed unit (O-DU), the capability information indicating a reporting capability of the O-RU for reporting timing error information. The O-RU may measure a timing error of the O-RU, the timing error comprising a residual error in a time delay at the O-RU after calibration. The O-RU may send a timing error report to the O-DU in accordance with the reporting capability of the O-RU, wherein the timing error report is indicative of the timing error.

### RELATED APPLICATIONS

This application claims the benefit of Greek Application No. 20230100049, filed Jan. 23, 2023, entitled “TIMING ERROR GROUP (TEG) REPORTING IN O-RAN DEPLOYMENT”, which is assigned to the assignee hereof, and incorporated herein in its entirety by reference.

### BACKGROUND

### 1. Field of Disclosure

The present disclosure relates generally to the field of wireless communications and positioning.

### 2. Description of Related Art

In a wireless communication system such as a cellular network, a base station having a disaggregated base station architecture (e.g., in accordance with open radio access network (O-RAN) implementation) may have separate functional units, including a radio unit (RU), distributed unit (DU), and central unit (CU). While this allows for different manufacturers to provide solutions for each unit type, the units still need to effectively communicate with each other. Under current applicable standards for communication between an RU and CU, for example, there are limitations in the reporting by an RU related to the timing of transmitted and/or received radio frequency (RF) signals. This can impact the determination of a timing error group (TEG) used for estimating a user equipment (UE) location.

### BRIEF SUMMARY

An example method of timing error group (TEG) reporting in an open radio access network (O-RAN) deployment of a base station in a wireless communication network, according to this disclosure, may comprise sending capability information from an O-RAN radio unit (O-RU) to an O-RAN distributed unit (O-DU), the capability information indicating a reporting capability of the O-RU for reporting timing error information. The method also may comprise measuring a timing error of the O-RU, the timing error comprising a residual error in a time delay at the O-RU after calibration. The method also may comprise sending a timing error report from the O-RU to the O-DU in accordance with the reporting capability of the O-RU, wherein the timing error report is indicative of the timing error.

Another example method of timing error group (TEG) reporting in an open radio access network (O-RAN) deployment of a base station in a wireless communication network, according to this disclosure, may comprise receiving capability information from an O-RAN radio unit (O-RU) with an O-RAN distributed unit (O-DU), the capability information indicating a reporting capability of the O-RU for reporting timing error information. The method also may comprise sending a command from the O-DU to the O-RU for a timing error report in accordance with the capability information. The method also may comprise subsequent to sending the command, receiving a timing error report from the O-RU with the O-DU in accordance with the command, wherein the timing error report is indicative of a timing error measured by the O-RU.

An example open radio access network (O-RAN) radio unit (O-RU) comprising: a transceiver, one or more processors communicatively coupled with the transceiver and the memory, wherein the one or more processors are configured to send capability information via the transceiver to an O-RAN distributed unit (O-DU), the capability information indicating a reporting capability of the O-RU for reporting timing error information. The one or more processors further may be configured to measure a timing error of the O-RU, the timing error comprising a residual error in a time delay at the O-RU after calibration. The one or more processors further may be configured to send a timing error report via the transceiver to the O-DU in accordance with the reporting capability of the O-RU, wherein the timing error report is indicative of the timing error.

An example open radio access network (O-RAN) distributed unit (O-DU) comprising: a transceiver, a memory, one or more processors communicatively coupled with the transceiver and the memory, wherein the one or more processors are configured to receive capability information via the transceiver from an O-RAN radio unit (O-RU), the capability information indicating a reporting capability of the O-RU for reporting timing error information. The one or more processors further may be configured to send a command via the transceiver to the O-RU for a timing error report in accordance with the capability information. The one or more processors further may be configured to subsequent to sending the command, receive a timing error report via the transceiver from the O-RU in accordance with the command, wherein the timing error report is indicative of a timing error measured by the O-RU.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 a diagram of positioning-related aspects of a 5^{th} generation (5G) new radio (NR) system, according to an embodiment.

FIG. 2 is a diagram illustrating an example disaggregated base station architecture, according to an embodiment.

FIGS. 3 and 4 are diagrams of the functionality at a radio unit (RU) and distributed unit (DU) in an open radio access network (O-RAN) distributed architecture, according to an embodiment.

FIG. 5 is a flow diagram of a method of timing error group (TEG) reporting in an O-RAN deployment of a base station in a wireless communication network, according to an embodiment.

FIG. 6 is a flow diagram of another method of TEG reporting in an O-RAN deployment of a base station in a wireless communication network, according to an embodiment.

FIG. 7 is a block diagram of an embodiment of an O-RAN RU (O-RU).

FIG. 8 is a block diagram of an embodiment of an O-RAN DU (O-DU).

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network. These signals may also be abbreviated herein as reference signals (RS). As described in more detail herein, such signals may comprise any of a variety of signal types and may not necessarily be limited to specific signals for positioning as defined in relevant wireless standards.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects of the subject matter described in this disclosure generally relate to the communication between a radio unit (RU) and a distributed unit (DU) in a disaggregated cellular base station. In particular, in a base station having an open radio access network (O-RAN) implementation, embodiments provide for reporting of a timing error by the O-RAN RU (O-RU) to the O-RAN DU (O-DU), which can account for a residual time delay at the O-RAN after calibration. This timing error can be relayed to a location server and/or user equipment (UE) and can be used to accurately identify a timing error group (TEG) from transmitted or received signals (e.g., RS resources) used to determine a location estimate of the UE. Embodiments may similarly provide for reporting of beam shape by the O-RU to the O-DU.

Particular aspects of the subject matter described in this disclosure can be implemented to realize one or more of the following potential advantages. As noted, the reporting of timing error information can enable the identification of a TEG when an O-RAN is used in the location estimation of a UE. As a person of ordinary skill in the art will appreciate, a TEG can be used to determine a more accurate location of the UE by identifying signals having the same (or substantially the same) group error. Similarly, the reporting of beam shape by the O-RU to the O-DU can ultimately provide for more accurate location estimation of a UE. These and other advantages will be apparent to a person of ordinary skill in the art from this disclosure. Details regarding how embodiments provide for the reporting of timing error and/or beam shape will be provided after a review of relevant technologies.

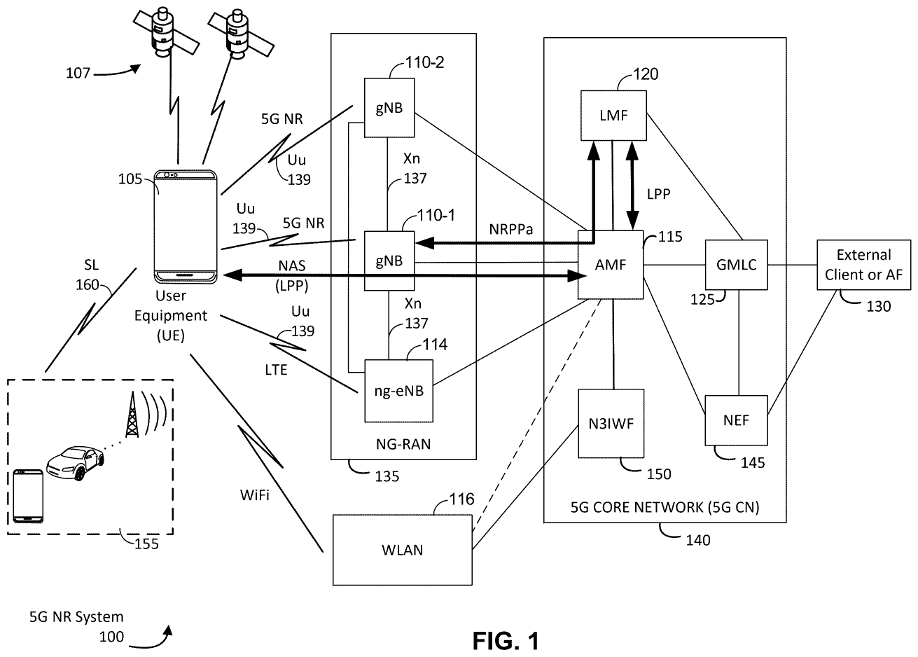

FIG. 1 is a diagram showing positioning-related aspects of a 5G NR system 100, which may implement the techniques herein for TEG reporting in an O-RAN deployment, according to an embodiment. The 5G NR system 100 may be configured to determine the location of a user equipment (UE) 105 by using access nodes, which may include NR NodeB (gNB) 110-1 and 110-2 (collectively and generically referred to herein as gNBs 110), ng-eNB 114, and/or WLAN 116 to implement one or more positioning methods. The gNBs 110 and/or the ng-eNB 114 may correspond with base stations described elsewhere herein, and the WLAN 116 may correspond with one or more access points described elsewhere herein. Optionally, the 5G NR system 100 additionally may be configured to determine the location of a UE 105 by using an LMF 120 (which may correspond with a location server as described elsewhere herein) to implement the one or more positioning methods. Here, the 5G NR system 100 comprises a UE 105, and components of a 5G NR network comprising a Next Generation (NG) Radio Access Network (RAN) (NG-RAN) 135 and a 5G Core Network (5G CN) 140. A 5G network may also be referred to as an NR network; NG-RAN 135 may be referred to as a 5G RAN or as an NR RAN; and 5G CN 140 may be referred to as an NG Core network.

The 5G NR system 100 may further utilize information from satellites 107. As previously indicated, satellites 107 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 107 may comprise NTN satellites that may be communicatively coupled with the LMF 120 and may operatively function as a transmit receive point (TRP) (or transmit point (TP)) in the NG-RAN 135. As such, satellites 107 may be in communication with one or more gNB 110.

It should be noted that FIG. 1 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR system 100. Similarly, the 5G NR system 100 may include a larger (or smaller) number of GNSS satellites 107, gNBs 110, ng-eNBs 114, Wireless Local Area Networks (WLANs) 116, Access and mobility Management Functions (AMF)s 115, external clients 130, and/or other components. The illustrated connections that connect the various components in the 5G NR system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 135 and 5G CN 140), etc. The UE 105 may also support wireless communication using a WLAN 116 which (like one or more RATs as described elsewhere herein) may connect to other networks, such as the Internet. The use of one or more of these RATs may allow the UE 105 to communicate with an external client 130 (e.g., via elements of 5G CN 140 not shown in FIG. 1, or possibly via a Gateway Mobile Location Center (GMLC) 125) and/or allow the external client 130 to receive location information regarding the UE 105 (e.g., via the GMLC 125). The external client 130 of FIG. 1 may correspond to an external client as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 135 shown in FIG. 1 may correspond to base stations as described elsewhere herein and may include gNBs 110. Pairs of gNBs 110 in NG-RAN 135 may be connected to one another (e.g., directly as shown in FIG. 1 or indirectly via other gNBs 110). The communication interface between base stations (gNBs 110 and/or ng-eNB 114) may be referred to as an Xn interface 137. Access to the 5G network is provided to UE 105 via wireless communication between the UE 105 and one or more of the gNBs 110, which may provide wireless communications access to the 5G CN 140 on behalf of the UE 105 using 5G NR. The wireless interface between base stations (gNBs 110 and/or ng-eNB 114) and the UE 105 may be referred to as a Uu interface 139. 5G NR radio access may also be referred to as NR radio access or as 5G radio access. In FIG. 1, the serving gNB for UE 105 is assumed to be gNB 110-1, although other gNBs (e.g. gNB 110-2) may act as a serving gNB if UE 105 moves to another location or may act as a secondary gNB to provide additional throughput and bandwidth to UE 105.

Base stations in the NG-RAN 135 shown in FIG. 1 may also or instead include a next generation evolved Node B, also referred to as an ng-eNB, 114. Ng-eNB 114 may be connected to one or more gNBs 110 in NG-RAN 135—e.g. directly or indirectly via other gNBs 110 and/or other ng-eNBs. An ng-eNB 114 may provide LTE wireless access and/or evolved LTE (eLTE) wireless access to UE 105. Some gNBs 110 (e.g. gNB 110-2) and/or ng-eNB 114 in FIG. 1 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 110 (e.g., gNB 110-2 and/or another gNB not shown) and/or ng-eNB 114 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 140, external client 130, or a controller) which may receive and store or use the data for positioning of at least UE 105. It is noted that while only one ng-eNB 114 is shown in FIG. 1, some embodiments may include multiple ng-eNBs 114. Base stations (e.g., gNBs 110 and/or ng-eNB 114) may communicate directly with one another via an Xn communication interface. Additionally or alternatively, base stations may communicate directly or indirectly with other components of the 5G NR system 100, such as the LMF 120 and AMF 115.

5G NR system 100 may also include one or more WLANs 116 which may connect to a Non-3GPP InterWorking Function (N3IWF) 150 in the 5G CN 140 (e.g., in the case of an untrusted WLAN 116). For example, the WLAN 116 may support IEEE 802.11 Wi-Fi access for UE 105 and may comprise one or more Wi-Fi APs (e.g., access points, as described elsewhere herein). Here, the N3IWF 150 may connect to other elements in the 5G CN 140 such as AMF 115. In some embodiments, WLAN 116 may support another RAT such as Bluetooth. The N3IWF 150 may provide support for secure access by UE 105 to other elements in 5G CN 140 and/or may support interworking of one or more protocols used by WLAN 116 and UE 105 to one or more protocols used by other elements of 5G CN 140 such as AMF 115. For example, N3IWF 150 may support IPSec tunnel establishment with UE 105, termination of IKEv2/IPSec protocols with UE 105, termination of N2 and N3 interfaces to 5G CN 140 for control plane and user plane, respectively, relaying of uplink (UL) and downlink (DL) control plane Non-Access Stratum (NAS) signaling between UE 105 and AMF 115 across an N1 interface. In some other embodiments, WLAN 116 may connect directly to elements in 5G CN 140 (e.g. AMF 115 as shown by the dashed line in FIG. 1) and not via N3IWF 150. For example, direct connection of WLAN 116 to 5GCN 140 may occur if WLAN 116 is a trusted WLAN for 5GCN 140 and may be enabled using a Trusted WLAN Interworking Function (TWIF) (not shown in FIG. 1) which may be an element inside WLAN 116. It is noted that while only one WLAN 116 is shown in FIG. 1, some embodiments may include multiple WLANs 116.

Access nodes may comprise any of a variety of network entities enabling communication between the UE 105 and the AMF 115. As noted, this can include gNBs 110, ng-eNB 114, WLAN 116, and/or other types of cellular base stations. However, access nodes providing the functionality described herein may additionally or alternatively include entities enabling communications to any of a variety of RATs not illustrated in FIG. 1, which may include non-cellular technologies. Thus, the term “access node,” as used in the embodiments described herein below, may include but is not necessarily limited to a gNB 110, ng-eNB 114 or WLAN 116.

In some embodiments, an access node, such as a gNB 110, ng-eNB 114, and/or WLAN 116 (alone or in combination with other components of the 5G NR system 100), may be configured to, in response to receiving a request for location information from the LMF 120, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 1 depicts access nodes (gNB 110, ng-eNB 114, and WLAN 116) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 135 and the EPC corresponds to 5GCN 140 in FIG. 1. The methods and techniques described herein for obtaining a civic location for UE 105 may be applicable to such other networks.

The gNBs 110 and ng-eNB 114 can communicate with an AMF 115, which, for positioning functionality, communicates with an LMF 120. The AMF 115 may support mobility of the UE 105, including cell change and handover of UE 105 from an access node (e.g., gNB 110, ng-eNB 114, or WLAN 116) of a first RAT to an access node of a second RAT. The AMF 115 may also participate in supporting a signaling connection to the UE 105 and possibly data and voice bearers for the UE 105. The LMF 120 may support positioning of the UE 105 using a CP location solution when UE 105 accesses the NG-RAN 135 or WLAN 116 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 120 may also process location service requests for the UE 105, e.g., received from the AMF 115 or from the GMLC 125. The LMF 120 may be connected to AMF 115 and/or to GMLC 125. In some embodiments, a network such as 5GCN 140 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 110, ng-eNB 114 and/or WLAN 116, and/or using assistance data provided to the UE 105, e.g., by LMF 120).

The Gateway Mobile Location Center (GMLC) 125 may support a location request for the UE 105 received from an external client 130 and may forward such a location request to the AMF 115 for forwarding by the AMF 115 to the LMF 120. A location response from the LMF 120 (e.g., containing a location estimate for the UE 105) may be similarly returned to the GMLC 125 either directly or via the AMF 115, and the GMLC 125 may then return the location response (e.g., containing the location estimate) to the external client 130.

A Network Exposure Function (NEF) 145 may be included in 5GCN 140. The NEF 145 may support secure exposure of capabilities and events concerning 5GCN 140 and UE 105 to the external client 130, which may then be referred to as an Access Function (AF) and may enable secure provision of information from external client 130 to 5GCN 140. NEF 145 may be connected to AMF 115 and/or to GMLC 125 for the purposes of obtaining a location (e.g. a civic location) of UE 105 and providing the location to external client 130.

As further illustrated in FIG. 1, the LMF 120 may communicate with the gNBs 110 and/or with the ng-eNB 114 using an NR Positioning Protocol annex (NRPPa) as defined in 3GPP Technical Specification (TS) 38.455. NRPPa messages may be transferred between a gNB 110 and the LMF 120, and/or between an ng-eNB 114 and the LMF 120, via the AMF 115. As further illustrated in FIG. 1, LMF 120 and UE 105 may communicate using an LTE Positioning Protocol (LPP) as defined in 3GPP TS 37.355. Here, LPP messages may be transferred between the UE 105 and the LMF 120 via the AMF 115 and a serving gNB 110-1 or serving ng-eNB 114 for UE 105. For example, LPP messages may be transferred between the LMF 120 and the AMF 115 using messages for service-based operations (e.g., based on the Hypertext Transfer Protocol (HTTP)) and may be transferred between the AMF 115 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network-based position methods such as ECID, AoA, uplink TDOA (UL-TDOA) and/or may be used by LMF 120 to obtain location related information from gNBs 110 and/or ng-eNB 114, such as parameters defining DL-PRS transmission from gNBs 110 and/or ng-eNB 114.

In the case of UE 105 access to WLAN 116, LMF 120 may use NRPPa and/or LPP to obtain a location of UE 105 in a similar manner to that just described for UE 105 access to a gNB 110 or ng-eNB 114. Thus, NRPPa messages may be transferred between a WLAN 116 and the LMF 120, via the AMF 115 and N3IWF 150 to support network-based positioning of UE 105 and/or transfer of other location information from WLAN 116 to LMF 120. Alternatively, NRPPa messages may be transferred between N3IWF 150 and the LMF 120, via the AMF 115, to support network-based positioning of UE 105 based on location related information and/or location measurements known to or accessible to N3IWF 150 and transferred from N3IWF 150 to LMF 120 using NRPPa. Similarly, LPP and/or LPP messages may be transferred between the UE 105 and the LMF 120 via the AMF 115, N3IWF 150, and serving WLAN 116 for UE 105 to support UE assisted or UE based positioning of UE 105 by LMF 120, described in more detail hereafter.

Positioning of the UE 105 in a 5G NR system 100 further may utilize measurements between the UE 105 and one or more other UEs 155 via a sidelink connection SL 160. As shown in FIG. 1, the one or more other UEs 155 may comprise any of a variety of different device types, including mobile phone, vehicle, roadside units (RSU), other device types, or any combination thereof. One or more position measurement signals sent via SL 160 to the UE 105 from the one or more other UEs 155, to the one or more other UEs 155 from the UE 105, or both. Various signals may be used for position measurement, including sidelink PRS (SL-PRS). In some instances, the position of at least one of the one or more of the other UEs 155 may be determined at the same time (e.g., in the same positioning session) as the position of the UE 105. In some embodiments, the LMF 120 may coordinate the transmission of positioning signals via SL 160 between the UE 105 and the one or more other UEs 155. Additionally or alternatively, the UE 105 and the one or more other UEs 155 may coordinate a positioning session between themselves, without an LMF 120 or even a Uu connection 139 to an access node of the NG-RAN 135. To do so, the UE 105 and the one or more other UEs 155 may communicate messages via the SL 160 using sidelink positioning protocol (SLPP). In some scenarios, the one or more other UEs 155 may have a Uu connection 139 with an access node of the NG-RAN 135 and/or Wi-Fi connection with WLAN 116 when the UE 105 does not. In such instances, the one or more other UEs 155 may operate as relay devices, relaying communications to the network (e.g., LMF 120) from the UE 105. In such instances, a plurality of other UEs 155 may form a chain between the UE 105 and the access node.

In a 5G NR system 100, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 130, LMF 120, or other device or service within the 5G network, the positioning method may be categorized as being UE assisted (or “network-based”).

With a UE-assisted position method, UE 105 may obtain location measurements and send the measurements to a location server (e.g., LMF 120) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 110, ng-eNB 114, and/or one or more access points for WLAN 116. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 107), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 120, an SLP, or broadcast by gNBs 110, ng-eNB 114, or WLAN 116).

With a network based position method, one or more base stations (e.g., gNBs 110 and/or ng-eNB 114), one or more APs (e.g., in WLAN 116), or N3IWF 150 may obtain location measurements (e.g., measurements of RSSI, RTT, RSRP, RSRQ, AoA, or TOA) for signals transmitted by UE 105, and/or may receive measurements obtained by UE 105 or by an AP in WLAN 116 in the case of N3IWF 150, and may send the measurements to a location server (e.g., LMF 120) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

Deployment of communication systems (such the 5G NR system 100 of FIG. 1) may be arranged in multiple manners with various components or constituent parts. In a 5G NR system, or network, a network node, a network entity, a mobility element of a network, a radio access network (RAN) node (e.g., access nodes 110, 114, and 116 of FIG. 1), a core network node, a network element, or a network equipment, such as a base station (BS), or one or more units (or one or more components) performing base station functionality, may be implemented in an aggregated or disaggregated architecture. For example, a BS (such as a Node B (NB), eNB, gNB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

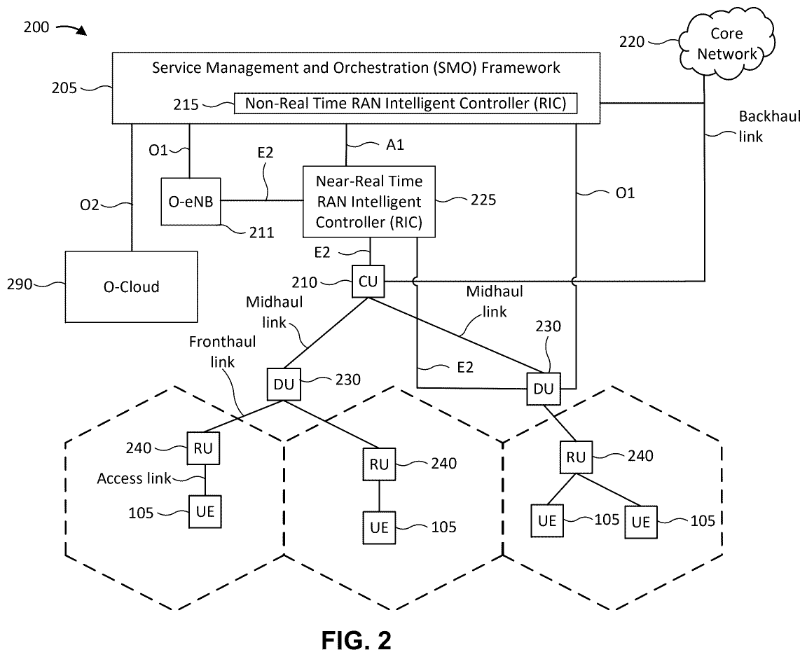

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 105 via one or more RF access links. In some implementations, the UE 105 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter, or transceiver (such as an RF transceiver), configured to receive and/or transmit signals over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 105. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

The implementation of an O-RAN configuration (e.g., in the manner illustrated in FIG. 2) can be subject to timing errors that can impact methods used by a network to determine the location of a UE. Specifically, UL signals (e.g., SRS) received by base station for positioning (e.g., UL-TDOA, UL-AoA, RTT) and/or DL signals (e.g., PRS) transmitted by the base station for positioning (e.g., DL-TDOA and DL-AoD) may include a timing error in the O-RU that, under current reporting standards, cannot be reported by the O-RU to the O-DU. Without accurate accounting of these timing errors, a TEG cannot be accurately identified. The positioning accuracy of a network-based positioning method utilizing such UL and/or DL signals therefore may be negatively impacted by a base station having an O-RAN configuration.

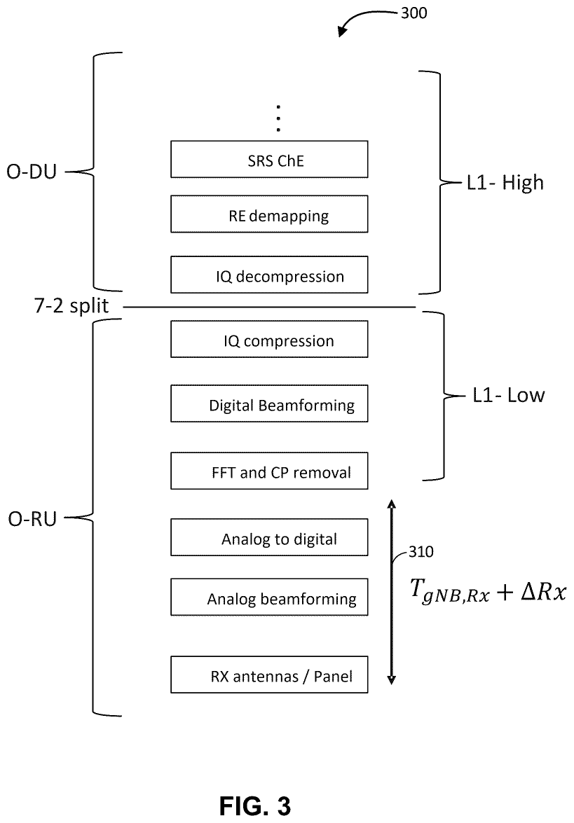

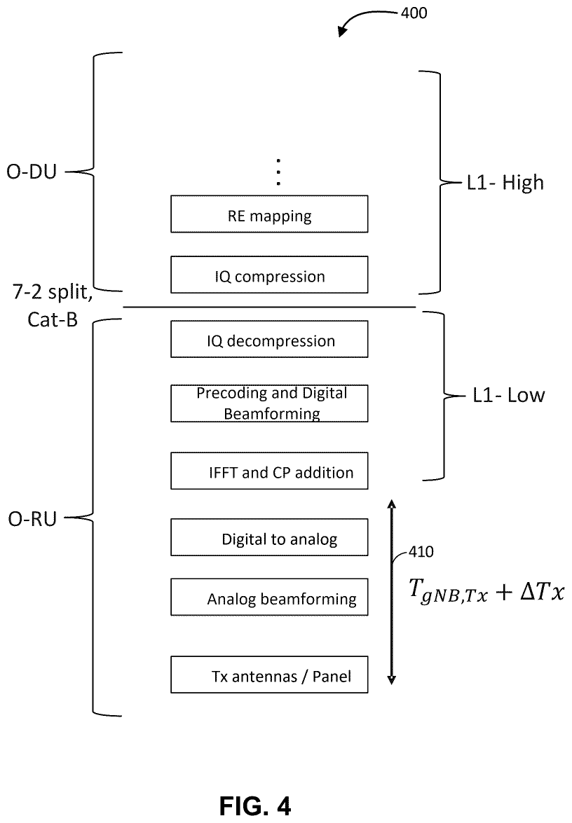

FIGS. 3 and 4 are diagrams of the functionality at an O-RU and O-DU, illustrating timing errors in an O-RAN. Here, a “7-2 split” is used to divide functions of a physical layer (Layer 1, or L1) into “high” (a.k.a., “High Phy”) and “low” (a.k.a., “Low Phy”) groups, in which O-RAN RU (O-RU, which may also stand for “open RU,” and which may correspond to RUs 240 of FIG. 2) performs the low L1 functions and the O-RAN DU (O-DU, which may also stand for “open DU,” and which may correspond with DUs 230 in FIG. 2) performs the high L1 functions. The receive/Rx functions 300 are illustrated in FIG. 3, and the transmit/Tx functions 400 are illustrated in FIG. 4.

Referring to the Rx functionality of FIG. 3, there is a time delay between the arrival of the RF signal at the Rx antennas/panel and the digitization and timestamping of the Rx signal in the baseband. This time delay is illustrated in FIG. 3 with double-sided arrow 310. The O-RU may implement calibration of the Rx time delay before it reports measurements made from UL RS resources (e.g., SRS), but there may be some remaining error. In FIG. 3, the calibration adjustment is represented by T_{gNB,Rx} and remaining time delay after the calibration, or Rx timing error, is represented by ΔRx.

An Rx timing error group, or Rx TEG, is associated with one or more measurements obtained from one or more received RS resources by one or more O-RUs. That is, one or more measurements may belong to an Rx TEG if Rx timing error differences between any pair of measurements in the Rx TEG are within a certain (e.g., predefined) margin. According to some embodiments, this margin may be dependent on accuracy requirements for a positioning method that uses measurements of UL RS resources received by one or more O-RUs for positioning

The Tx functionality of FIG. 4 is analogous. Here, there is a time delay between the generation of the Tx digital signal at the baseband and the transmission of the RF signal from the Tx antennas/panel. This time delay is illustrated in FIG. 4 with double-sided arrow 410. The O-RU may implement calibration of the Tx time delay before transmitting DL RS resources (e.g., PRS), but there may be some remaining error. In FIG. 4, the calibration adjustment is represented by T_{gNB,Tx}, and remaining time delay after the calibration, or Tx timing error, is represented by ΔTx.

A Tx timing error group, or Tx TEG, is associated with one or more RS resources transmitted from one or more RS resources by one or more O-RUs. That is, one or more RS resources may belong to a Tx TEG if Tx timing error differences between any pair of measurements in the Tx TEG are within a certain (e.g., predefined) margin. According to some embodiments, and similar to Rx TEG, this margin may be dependent on accuracy requirements for a positioning method that uses RS resources transmitted by the by one or more O-RUs for positioning

According to 3GPP standards, a TEG-ID may be assigned to a group of measurements for Rx (or RxTx) TEG or a group of RS resources for Tx TEG that experienced similar timing errors. The determination of a position estimate of a UE can exploit this to improve accuracy with differential techniques (e.g., using an assumption that the timing error between RS resources in a TEG is negligible). Similar timing errors are generally associated with similar processing chains, e.g., same Tx/Rx panel/antenna. However, a TEG-ID abstracts away the implementation details to captures what is needed to improve positioning accuracy, regardless of differences in hardware. The relevant TEG-IDs may be reported to a location server (e.g., LMF) in UE-assisted positioning and may be reported to a UE (e.g., via the LMF) in UE-based positioning.

In O-RAN the varying types of configurations and hardware characteristics can impact Rx TEG (e.g., based on SRS) and/or Tx TEG (e.g., based on PRS). In an O-RU, components used from RF antennas/panel to baseband processing may belong to different vendors with different product architectures. That said, for a given O-RU hardware and configuration (e.g., for receiving SRS or transmitting PRS), the Rx for Tx any errors can be assumed to be static (assuming a nominal condition for temperature). Configurations such as a number of antenna elements (e.g., 8, 16, or 64) to use and/or a beam pattern to use may be controlled by the O-DU.

Currently the relevant O-RAN specifications (control user synchronization plane (CUS-plane) management plane (M-plane) specifications) support O-RU calibration and data blanking to provide an interval for antenna calibration at O-RU. This may correspond to the calibration described with respect to FIGS. 3 and 4, resulting in a determination of the values of T_{gNB,Rx} and T_{gNB,Tx}, respectively. The command for O-RU calibration may be conveyed via the M-plane.

However, the O-RAN specification currently falls short of supporting a TEG report in O-RAN. O-RAN calibration cannot provide an Rx or Tx timing error; this measurement report is not specified under the current O-RAN specification. Moreover, the specification currently does not allow the O-RU to dynamically report the Rx or Tx timing errors (e.g., ΔRx and ΔTx in FIGS. 3 and 4, respectively) to the O-DU, which can change based on configuration and/or periodicity, as detailed above. To fully support TEG report for positioning, and O-RU may need to report such updates to the O-DU, either in response to query from DU or in response to configured events (e.g., change in SRS/PRS periodicity, or within X milliseconds after specific calibration-gaps, or a combination of these).

As noted, embodiments herein address these and other issues by supporting Rx TEG and/or Tx TEG reporting (which may include reporting of the underlying Tx and/or Rx timing error) from an O-RU to an O-DU. Different reporting mechanisms are described hereafter. The reported information can ultimately be relayed to a location server (e.g., LMF) or a UE (e.g., via the location server) to determine UE positioning in light of the Rx and/or Tx timing errors/TEG of the O-RU.

According to some embodiments, new capabilities and reporting types can be implemented at the O-RU. As noted, Rx and Tx timing errors (and, correspondingly, Rx and Tx TEG) may change based on events at the O-RU, such as temperature change an updated calibration of group-delays (e.g., in a scheduled calibration gap, which is already supported in ORAN). According to some embodiments, O-RU may be capable of providing static or dynamic reporting of the timing errors/TEG. Thus, an O-RU may indicate to an O-DU the type of reporting it may support (e.g., static, dynamic, or no timing error/TEG report capability). This capability may be added to the existing O-RU capability framework.

The contents of the reports provided from the O-RU to the O-DU may vary, depending on reporting type. For example, dynamic reports (which may be preferable over static reports in most scenarios) may be recorded autonomously, according to some embodiments. In such embodiments, the O-RU can request O-DU to reserve grants for reporting in U-plane data flow. In such embodiments, reserved resources may be allocated to the O-RU to request these grant (e.g., via a periodic reporting request). Additionally or alternatively, dynamic reports by the O-RU may be provided in response to query from the O-DU and/or in response to configured events (e.g., SRS or PRS periodicity, after the O-RU enters energy saving mode, or the like).

Depending on desired functionality, reporting may be performed via the M-plane and/or user plane (U-plane). According to some embodiments, for static reports, all TEG-related signaling (e.g., including underlying Rx and/or Tx timing errors) can be conveyed via M-plane. Additionally or alternatively, reporting (e.g., static and/or dynamic) can be supported via U-plane by granting some fields in the U-plane data flow to carry an Rx timing error measurement and/or a Tx timing error measurement.

According to some embodiments, an O-RU may report beam shapes for UL-AoA. For UL-AoA, the O-DU performs angle computation of received UL RS resources (e.g., SRS) based on Power Difference of Arrival (PDOA) and/or RSRP of different SRS resources. Beam shape may be reported by the O-RU utilizing one or more different formats of beam pattern/shape reporting (e.g., elemental gain pattern, shape of antenna element, for the like), which may also include reporting of the geometry of antenna elements in the panel. Moreover, according to some embodiments, the O-RU's capability for reporting beam shape may be communicated to the O-DU in the same manner described above with respect to reporting timing errors/TEG. According to some embodiments, this capability information provided by the O-RU to the O-DU may not only include whether the O-RU is capable of reporting beam shape, but also an indication of one or more formats for reporting beam shape supported by the O-RU. According to some embodiments, the O-DU may be able to send a request to the O-RU for a report of the beam shape with specified format by O-DU command (which may be relayed via a C-plane message). Similar to timing error/TEG reporting, dynamic reporting of beam shape can be beneficial in some scenarios. This can include, for example, reporting when a beam shape has been updated based on calibration and/or, in cases in which the O-RU is capable of autonomously selecting from a very large beam codebook, reporting a beam shape use on the fly (e.g., in cases when the codebook may be too large to report all the beam-shapes up-front).

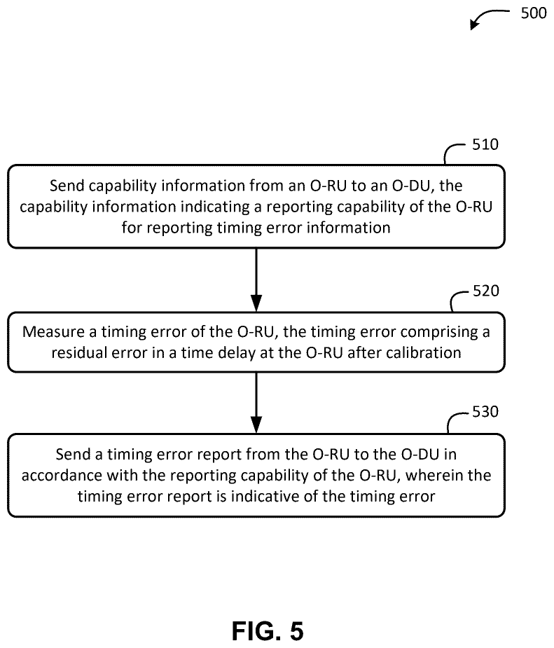

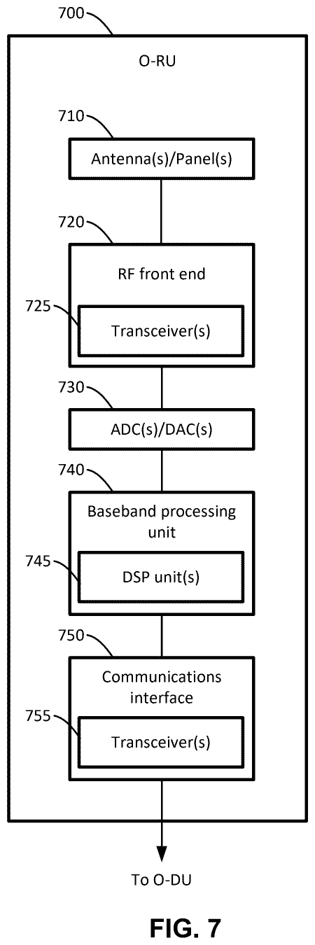

FIG. 5 is a flow diagram of a method 500 of TEG reporting in an O-RAN deployment of a base station in a wireless communication network, which may reflect aspects of the embodiments described above. Means/structure for performing one or more of the operations of method 500 may comprise, for example, by hardware and/or software components of an O-RU. Example components of an O-RU described hereafter with respect to FIG. 7.

At block 510, the functionality comprises sending capability information from an O-RU to an O-DU, the capability information indicating a reporting capability of the O-RU for reporting timing error information. As noted in the embodiments described herein, the contents of this capability information may vary, depending on desired functionality. For example, this capability information may indicate whether an O-RU is capable of reporting TEG-related information, underlying Rx and/or Tx timing errors, beam shape, or combination thereof. For example, according to some instances, the capability information may indicate a reporting capability of the O-RU for reporting beam shape information. In such instances, embodiments of the method 500 may further comprise determining a beam shape associated with a wireless signal received by the O-RU and sending a beam shape report from the O-RU to the O-DU in accordance with the reporting capability of the O-RU, wherein the beam shape report is indicative of the beam shape associated with the wireless signal. Further, in such embodiments, the reporting capability of the O-RU for reporting beam shape information may include an indication of one or more formats in which the O-RU is capable of reporting the beam shape information. According to some embodiments, the reporting capability of the O-RU may comprise a dynamic reporting capability, a static reporting capability, or both.

Means for performing functionality at block 510 may comprise baseband processing unit 740 (which may include one or more DSP units 745), communications interface 750 (which may include one or more transceivers 755), and/or other components of an O-RU 700, e.g., as illustrated in FIG. 7.

At block 520, the functionality comprises measuring a timing error of the O-RU, the timing error comprising a residual error in a time delay at the O-RU after calibration. Depending on the circumstances, the timing error may comprise an Rx timing error (e.g., ΔRx), a Tx timing error (e.g., ΔTx), or both. As noted herein, according to some embodiments the O-RU may be capable of dynamic TEG reporting. In such embodiments, performing the underlying measurements for the dynamic TEG reporting may be triggered by certain events that can change the timing error, such as a change in configuration or periodicity, as described herein.

Means for performing functionality at block 520 may comprise one or more antennas/panels 710, an RF front end 720 (which may include one or more transceivers 725, ADCs/DACs 730, baseband processing unit 740 (which may include one or more DSP units 745), communications interface 750 (which may include one or more transceivers 755), and/or other components of an O-RU 700, e.g., as illustrated in FIG. 7.

At block 530, the functionality comprises sending a timing error report from the O-RU to the O-DU in accordance with the reporting capability of the O-RU, wherein the timing error report is indicative of the timing error. Depending on desired functionality, the timing error report may include the timing error itself and/or an indication of a TEG based on the timing error. Additionally or alternatively, the timing error report they include an Rx TEG identifier (TEG-ID), a Tx TEG-ID, or both.

Is noted in the embodiments described herein, the way in which the timing error report is sent may vary, depending on desired for example, in some embodiments, sending the timing error report may comprise sending a static timing error report via the M-plane. Additionally or alternatively, sending the timing error report may comprise sending a dynamic timing error report via the U-plane. According to some embodiments, a dynamic timing error report may be sent, in which case it may be sent using resources granted to the O-RU by the O-DU for reporting the timing error information. In such embodiments, prior to sending the dynamic timing error report: the O-RU may send a request for the resources to the O-DU, and the O-RU may receive a grant for the resources from the O-DU. According to some embodiments, sending the timing error report is responsive to the O-RU receiving a request for the timing error report from the O-DU. Additionally or alternatively, sending the timing error report may be responsive to: a change in periodicity of a sounding reference signal (SRS) received by the O-RU from a transmitting device, a change in periodicity of a positioning reference signal (PRS) transmitted by the O-RU, the O-RU entering an energy savings mode, or a combination thereof.

Means for performing functionality at block 530 may comprise one or more antennas/panels 710, an RF front end 720 (which may include one or more transceivers 725, ADCs/DACs 730, baseband processing unit 740 (which may include one or more DSP units 745), communications interface 750 (which may include one or more transceivers 755), and/or other components of an O-RU 700, e.g., as illustrated in FIG. 7.

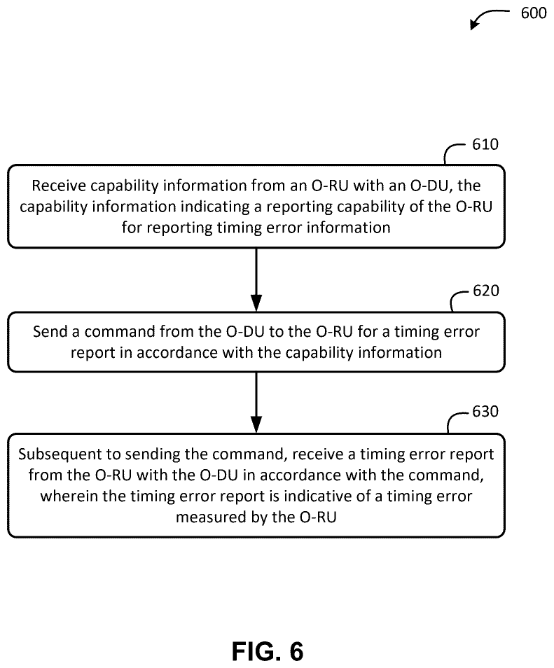

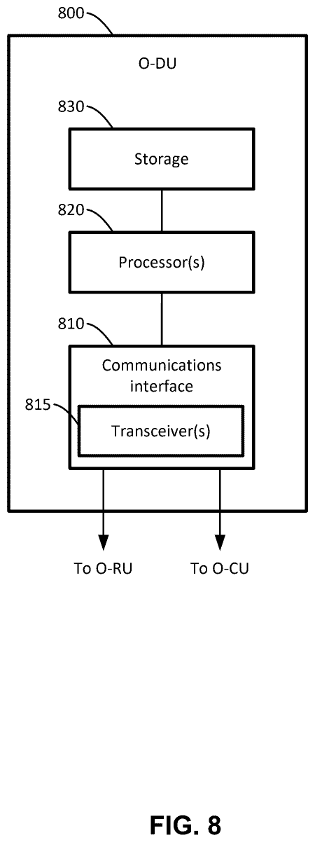

FIG. 6 is a flow diagram of another method 600 of TEG reporting in an O-RAN deployment of a base station in a wireless communication network, which may reflect aspects of the embodiments described above. The method 600 may reflect the functionality that may be performed by an O-DU when an O-RU performs the method 500. Means/structure for performing one or more of the operations of method 600 may comprise, for example, by hardware and/or software components of an O-DU. Example components of an O-DU described hereafter with respect to FIG. 8.

At block 610, the functionality comprises receiving capability information from an O-RU with an O-DU, the capability information indicating a reporting capability of the O-RU for reporting timing error information. Again, according to some embodiments, this capability information may indicate whether an O-RU is capable of reporting TEG-related information, underlying Rx and/or Tx timing errors, beam shape, or combination thereof. For example, according to some instances, the capability information may indicate a reporting capability of the O-RU for reporting beam shape information. According to some embodiments, the reporting capability of the O-RU may comprise a dynamic reporting capability, a static reporting capability, or both.

Means for performing functionality at block 610 may comprise a communications interface 810 (which may include one or more transceivers 815), one or more processors 820, storage 830, and/or other components of an O-DU 800, e.g., as illustrated in FIG. 8.

At block 620, the functionality comprises sending a command from the O-DU to the O-RU for a timing error report in accordance with the capability information. According to some embodiments, the command they be sent from the O-DU to the O-RU via the C-plane.

Means for performing functionality at block 620 may comprise a communications interface 810 (which may include one or more transceivers 815), one or more processors 820, storage 830, and/or other components of an O-DU 800, e.g., as illustrated in FIG. 8.

At block 630, the functionality comprises subsequent to sending the command, receiving a timing error report from the O-RU with the O-DU in accordance with the command, wherein the timing error report is indicative of a timing error measured by the O-RU.

The method of claim 12, wherein the timing error comprises an Rx timing error, a Tx timing error, or both. According to some embodiments, the timing error report a comprise a dynamic timing error report received via the U-plane. In embodiments in which the O-RU is capable of providing a dynamic timing error report, the method may further comprise granting resources to the O-RU with the O-DU for reporting the timing error information. As noted, the granting of such resources may be in response to a request for the resources from the O-RU.

Means for performing functionality at block 630 may comprise a communications interface 810 (which may include one or more transceivers 815), one or more processors 820, storage 830, and/or other components of an O-DU 800, e.g., as illustrated in FIG. 8.

FIG. 7 is a block diagram of an embodiment of an O-RU 700, which may be used, in whole or in part, to provide functions of an O-RU as described herein. This can generally encompass the O-RU functionality as described with respect to FIGS. 1-6, and specifically the functionality of the O-RU as illustrated in FIGS. 3 and 4, and some or all of the operations illustrated in FIG. 5. It should be noted that FIG. 8 is meant only to provide a generalized illustration of various components, any or all of which may be utilized as appropriate. Moreover, the various components of the O-RU 700 may be communicatively coupled via a bus and/or one or more communication links in the manner illustrated, or in an alternative configuration, as desired.

As illustrated, the O-RU 700 may comprise one or more antennas and/or antenna panels 710 communicatively coupled with an RF front-end 720 which may comprise one or more transceivers 725, which may comprise receivers, transmitters, or any combination thereof. The RF front-end 720 may include circuitry and/or other hardware to perform initial processing of Rx signals received via the antenna(s)/panel(s) 710 and/or final processing of Tx signals to be transmitted via the antenna(s)/panel(s) 710. This can include implementing, for example, implementing low-noise and/or power amplification, filtering, analog beamforming (e.g., corresponding to the beamforming in FIGS. 3 and 4), or the like. As described elsewhere herein, the reception of wireless Rx signals and transmission of wireless Tx signals by the O-RU 700 may be part of a Uu interface (and/or other wireless link) between a UE and a base station (e.g., of which the O-RU 700 may be a part). Wireless signals may be transmitted and received in accordance with governing wireless standards (e.g., as defined by 3GPP).

The O-RU 700 may further comprise one or more analog-to-digital converters (ADCs) and/or digital-to-analog converters (DACs) at block 730. Generally put, these ADC(s)/DAC(s) may comprise circuitry that provides conversion of Rx signals received by the O-RU 700 and provided by the RF front-end 720 from analog to digital for baseband processing by the baseband processing unit 740 and/or conversion of Tx signals provided by the baseband processing unit 740 from digital to analog for final analog processing by the RF front-end 720 before transmission by the O-RU 700.

As illustrated, the baseband processing unit 740 may comprise one or more digital signal processing (DSP) units 745 and/or one or more other types of processors (e.g., microprocessor, microcontroller, etc.) for processing received Rx signals and/or Tx signals to be transmitted. The baseband processing unit 740 may perform the L1-low (PHY low) functionality illustrated in FIGS. 3 and 4, as previously described. This may include a Fast Fourier Transform (FFT), inverse Fast Fourier Transform (IFFT), removal and/or addition of cyclic prefix (CP), digital beamforming, recoding, IQ compression and/or decompression, or any combination thereof. As described herein, this may be in accordance with an O-RAN 7-2 split.

Finally, the communications interface 750 may include one or more transceivers 755 for communicating with the O-DU. Again, the transceiver(s) 755 may comprise receivers, transmitters, or any combination thereof. As previously noted, communications with the O-DU may be made via a fronthaul link and in accordance with governing standards to convey information via U-plane, C-plane, M-plane, synchronization plane (S-plane), or any combination thereof.

It can be noted that the various components of the O-RU 700 may further include circuitry not explicitly illustrated in FIG. 7. This may include, for example, one or more non-transitory storage devices, which can comprise, without limitation, random-access memory (RAM) and/or read-only memory (ROM), which can be programmable, flash-updateable, and/or the like. Such storage devices may be configured to implement any appropriate data stores, including without limitation, various file systems, database structures, and/or the like.

FIG. 8 is a block diagram of an embodiment of an O-DU 800, which may be used, in whole or in part, to provide functions of an O-DU as described herein. This can generally encompass the O-DU functionality as described with respect to FIGS. 1-6, and specifically the functionality of the O-DU as illustrated in FIGS. 3 and 4, and some or all of the operations illustrated in FIG. 6. It should be noted that FIG. 8 is meant only to provide a generalized illustration of various components, any or all of which may be utilized as appropriate. Moreover, the various components of the O-DU 800 may be communicatively coupled via a bus and/or one or more communication links in the manner illustrated, or in an alternative configuration, as desired.

As illustrated, the O-DU 800 may comprise a communications interface 810, which may comprise one or more transceivers 815. Again, the one or more transceivers may comprise one or more receivers, transmitters, or any combination thereof. The communications interface 810 may provide interfaces to O-RU and O-CU as shown. As previously noted, communications with the O-RU may be made via a fronthaul link, and made in accordance with governing standards to convey information via U-plane, C-plane, M-plane, synchronization plane (S-plane), or any combination thereof. Communications with the O-CU may be made via a midhaul link and/or F1 interface, which may also be made in accordance with applicable communications standards.

As illustrated, the communications interface 810 may be communicatively coupled with one or more processors 820. The processor(s) 820 may comprise without limitation one or more general-purpose processors, one or more special-purpose processors (such as digital signal processing chips, graphics acceleration processors, system-on-a-chip circuitry, and/or the like), and/or other processing structure, which can be communicatively coupled with storage 830 and configured to perform functionality including the L1-high (PHY low) functionality illustrated in FIGS. 3 and 4, as previously described. This may include IQ decompression, resource element (RE) demapping and/or mapping, SRS ChE, or any combination thereof. Again, the functions performed by the O-DU 800 (using processor(s) 820) may be in accordance with an O-RAN 7-2 split.

The storage 830 may comprise any of a variety storage types they can be used by the processor(s) 820 perform the functionality described above. For example, the storage 830 may comprise one or more non-transitory storage devices, which can comprise, without limitation, RAM and/or ROM, which can be programmable, flash-updateable, and/or the like. Such storage devices may be configured to implement any appropriate data stores, including without limitation, various file systems, database structures, and/or the like.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of timing error group (TEG) reporting in an open radio access network (O-RAN) deployment of a base station in a wireless communication network, the method comprising: sending capability information from an O-RAN radio unit (O-RU) to an O-RAN distributed unit (O-DU), the capability information indicating a reporting capability of the O-RU for reporting timing error information; measuring a timing error of the O-RU, the timing error comprising a residual error in a time delay at the O-RU after calibration; and sending a timing error report from the O-RU to the O-DU in accordance with the reporting capability of the O-RU, wherein the timing error report is indicative of the timing error.

Clause 2. The method of clause 1, wherein the timing error comprises an Rx timing error, a Tx timing error, or both.

Clause 3. The method of any one of clauses 1-2 wherein timing error report includes an Rx TEG identifier (TEG-ID), a Tx TEG-ID, or both.

Clause 4. The method of clause 3 wherein the reporting capability of the O-RU comprises a dynamic reporting capability, a static reporting capability, or both.

Clause 5. The method of any one of clauses 1-4 wherein sending the timing error report comprises sending a static timing error report via a management plane (M-plane).

Clause 6. The method of any one of clauses 1-5 wherein sending the timing error report comprises sending a dynamic timing error report via a user plane (U-plane).

Clause 7. The method of any one of clauses 1-6 wherein the dynamic timing error report is sent using resources granted to the O-RU by the O-DU for reporting the timing error information.

Clause 8. The method of clause 7 wherein, prior to sending the dynamic timing error report the O-RU sends a request for the resources to the O-DU; and the O-RU receives a grant for the resources from the O-DU.

Clause 9. The method of any one of clauses 1-8 wherein sending the timing error report is responsive to the O-RU receiving a request for the timing error report from the O-DU.

Clause 10. The method of any one of clauses 1-9 wherein sending the timing error report is responsive to: a change in periodicity of a sounding reference signal (SRS) received by the O-RU from a transmitting device, a change in periodicity of a positioning reference signal (PRS) transmitted by the O-RU, the O-RU entering an energy savings mode, or a combination thereof.

Clause 11. The method of any one of clauses 1-10 wherein the capability information further indicates a reporting capability of the O-RU for reporting beam shape information, the method further comprising: determining a beam shape associated with a wireless signal received by the O-RU; and sending a beam shape report from the O-RU to the O-DU in accordance with the reporting capability of the O-RU, wherein the beam shape report is indicative of the beam shape associated with the wireless signal.

Clause 12. The method of clause 11 wherein the reporting capability of the O-RU for reporting beam shape information includes an indication of one or more formats in which the O-RU is capable of reporting the beam shape information.

Clause 13. A method of timing error group (TEG) reporting in an open radio access network (O-RAN) deployment of a base station in a wireless communication network, the method comprising: receiving capability information from an O-RAN radio unit (O-RU) with an O-RAN distributed unit (O-DU), the capability information indicating a reporting capability of the O-RU for reporting timing error information; sending a command from the O-DU to the O-RU for a timing error report in accordance with the capability information; and subsequent to sending the command, receiving a timing error report from the O-RU with the O-DU in accordance with the command, wherein the timing error report is indicative of a timing error measured by the O-RU.

Clause 14. The method of clause 13, wherein the command is sent from the O-DU to the O-RU via a control plane (C-plane).

Clause 15. The method of any one of clauses 13-14 wherein the timing error comprises an Rx timing error, a Tx timing error, or both.

Clause 16. The method of any one of clauses 13-15 wherein the reporting capability of the O-RU comprises a dynamic reporting capability, a static reporting capability, or both.

Clause 17. The method of any one of clauses 13-16 wherein the timing error report comprises a dynamic timing error report received via a user plane (U-plane).

Clause 18. The method of any one of clauses 13-17 wherein the timing error report comprises a dynamic timing error report, and wherein the method further comprises granting resources to the O-RU with the O-DU for reporting the timing error information.

Clause 19. An open radio access network (O-RAN) radio unit (O-RU) comprising: a transceiver; and one or more processors communicatively coupled with the transceiver, wherein the one or more processors are configured to: send capability information via the transceiver to an O-RAN distributed unit (O-DU), the capability information indicating a reporting capability of the O-RU for reporting timing error information; measure a timing error of the O-RU, the timing error comprising a residual error in a time delay at the O-RU after calibration; and send a timing error report via the transceiver to the O-DU in accordance with the reporting capability of the O-RU, wherein the timing error report is indicative of the timing error.

Clause 20. The O-RU of clause 19, wherein the timing error comprises an Rx timing error, a Tx timing error, or both.

Clause 21. The O-RU of any one of clauses 19-20 wherein, to indicate the reporting capability of the O-RU, the one or more processors are configured to indicate, in the capability information, a dynamic reporting capability, a static reporting capability, or both.

Clause 22. The O-RU of any one of clauses 19-21 wherein the one or more processors are configured to send the timing error report responsive to the O-RU receiving a request for the timing error report from the O-DU.

Clause 23. The O-RU of any one of clauses 19-22 wherein the one or more processors are configured to send the timing error report responsive to: a change in periodicity of a sounding reference signal (SRS) received by the O-RU from a transmitting device, a change in periodicity of a positioning reference signal (PRS) transmitted by the O-RU, the O-RU entering an energy savings mode, or a combination thereof.

Clause 24. The O-RU of any one of clauses 19-23 wherein the one or more processors are configured to include, in the capability information, a reporting capability of the O-RU for reporting beam shape information, and wherein the one or more processors are further configured to: determine a beam shape associated with a wireless signal received by the O-RU; and send a beam shape report via the transceiver to the O-DU in accordance with the reporting capability of the O-RU, wherein the beam shape report is indicative of the beam shape associated with the wireless signal.

Clause 25. The O-RU of clause 24 wherein the one or more processors are configured to include, in the reporting capability of the O-RU for reporting beam shape information, an indication of one or more formats in which the O-RU is capable of reporting the beam shape information.

Clause 26. An open radio access network (O-RAN) distributed unit (O-DU) comprising: a transceiver; a memory; and one or more processors communicatively coupled with the transceiver and the memory, wherein the one or more processors are configured to: receive capability information via the transceiver from an O-RAN radio unit (O-RU), the capability information indicating a reporting capability of the O-RU for reporting timing error information; send a command via the transceiver to the O-RU for a timing error report in accordance with the capability information; and subsequent to sending the command, receive a timing error report via the transceiver from the O-RU in accordance with the command, wherein the timing error report is indicative of a timing error measured by the O-RU.

Clause 27. The O-DU of clause 26, wherein the one or more processors are configured to send the command to the O-RU via a control plane (C-plane).

Clause 28. The O-DU of any one of clauses 26-27 wherein, to receive the timing error report, the one or more processors are configured to receive an indication of an Rx timing error, a Tx timing error, or both.

Clause 29. The O-DU of any one of clauses 26-28 wherein, to receive the reporting capability of the O-RU, the one or more processors are configured to receive an indication of a dynamic reporting capability, a static reporting capability, or both.

Clause 30. The O-DU of any one of clauses 26-29 wherein, to receive the timing error report, the one or more processors are configured to receive a dynamic timing error report via a user plane (U-plane).

Clause 31. An apparatus having means for performing the method of any one of clauses 1-18.

Clause 32. A non-transitory computer-readable medium storing instructions, the instructions comprising code for performing the method of any one of clauses 1-18.

1. A method of timing error group (TEG) reporting in an open radio access network (O-RAN) deployment of a base station in a wireless communication network, the method comprising:
sending capability information from an O-RAN radio unit (O-RU) to an O-RAN distributed unit (O-DU), the capability information indicating a reporting capability of the O-RU for reporting timing error information;
measuring a timing error of the O-RU, the timing error comprising a residual error in a time delay at the O-RU after calibration; and
sending a timing error report from the O-RU to the O-DU in accordance with the reporting capability of the O-RU, wherein the timing error report is indicative of the timing error.

2. The method of claim 1, wherein the timing error comprises an Rx timing error, a Tx timing error, or both.

3. The method of claim 1, wherein timing error report includes an Rx TEG identifier (TEG-ID), a Tx TEG-ID, or both.

4. The method of claim 1, wherein the reporting capability of the O-RU comprises a dynamic reporting capability, a static reporting capability, or both.

5. (canceled)

6. (canceled)

7. (canceled)

8. (canceled)

9. The method of claim 1, wherein sending the timing error report is responsive to the O-RU receiving a request for the timing error report from the O-DU.

10. The method of claim 1, wherein sending the timing error report is responsive to:
a change in periodicity of a sounding reference signal (SRS) received by the O-RU from a transmitting device,
a change in periodicity of a positioning reference signal (PRS) transmitted by the O-RU,
the O-RU entering an energy savings mode, or
a combination thereof.

11. The method of claim 1, wherein the capability information further indicates a reporting capability of the O-RU for reporting beam shape information, the method further comprising:
determining a beam shape associated with a wireless signal received by the O-RU; and
sending a beam shape report from the O-RU to the O-DU in accordance with the reporting capability of the O-RU, wherein the beam shape report is indicative of the beam shape associated with the wireless signal.

12. The method of claim 11, wherein the reporting capability of the O-RU for reporting beam shape information includes an indication of one or more formats in which the O-RU is capable of reporting the beam shape information.

13. (canceled)

14. (canceled)

15. (canceled)

16. (canceled)

17. (canceled)

18. (canceled)

19. An open radio access network (O-RAN) radio unit (O-RU) comprising:
a transceiver; and
one or more processors communicatively coupled with the transceiver, wherein the one or more processors are configured to:
send capability information via the transceiver to an O-RAN distributed unit (O-DU), the capability information indicating a reporting capability of the O-RU for reporting timing error information;
measure a timing error of the O-RU, the timing error comprising a residual error in a time delay at the O-RU after calibration; and
send a timing error report via the transceiver to the O-DU in accordance with the reporting capability of the O-RU, wherein the timing error report is indicative of the timing error.

20. The O-RU of claim 19, wherein the timing error comprises an Rx timing error, a Tx timing error, or both.

21. The O-RU of claim 19, wherein, to indicate the reporting capability of the O-RU, the one or more processors are configured to indicate, in the capability information, a dynamic reporting capability, a static reporting capability, or both.

22. The O-RU of claim 19, wherein the one or more processors are configured to send the timing error report responsive to the O-RU receiving a request for the timing error report from the 0-DU.

23. The O-RU of claim 19, wherein the one or more processors are configured to send the timing error report responsive to:
a change in periodicity of a sounding reference signal (SRS) received by the O-RU from a transmitting device,
a change in periodicity of a positioning reference signal (PRS) transmitted by the O-RU,
the O-RU entering an energy savings mode, or
a combination thereof.

24. The O-RU of claim 19, wherein the one or more processors are configured to include, in the capability information, a reporting capability of the O-RU for reporting beam shape information, and wherein the one or more processors are further configured to:
determine a beam shape associated with a wireless signal received by the O-RU; and
send a beam shape report via the transceiver to the 0-DU in accordance with the reporting capability of the O-RU, wherein the beam shape report is indicative of the beam shape associated with the wireless signal.

25. The O-RU of claim 24, wherein the one or more processors are configured to include, in the reporting capability of the O-RU for reporting beam shape information, an indication of one or more formats in which the O-RU is capable of reporting the beam shape information.

26. An open radio access network (O-RAN) distributed unit (O-DU) comprising:
a transceiver;
a memory; and
one or more processors communicatively coupled with the transceiver and the memory, wherein the one or more processors are configured to:
receive capability information via the transceiver from an O-RAN radio unit (O-RU), the capability information indicating a reporting capability of the O-RU for reporting timing error information;
send a command via the transceiver to the O-RU for a timing error report in accordance with the capability information; and
subsequent to sending the command, receive a timing error report via the transceiver from the O-RU in accordance with the command, wherein the timing error report is indicative of a timing error measured by the O-RU.

27. The O-DU of claim 26, wherein the one or more processors are configured to send the command to the O-RU via a control plane (C-plane).

28. The O-DU of claim 26, wherein, to receive the timing error report, the one or more processors are configured to receive an indication of an Rx timing error, a Tx timing error, or both.

29. The O-DU of claim 26, wherein, to receive the reporting capability of the O-RU, the one or more processors are configured to receive an indication of a dynamic reporting capability, a static reporting capability, or both.

30. The O-DU of claim 29, wherein, to receive the timing error report, the one or more processors are configured to receive a dynamic timing error report via a user plane (U-plane).
